(19) United States
(12) Patent Application Publication
(10) Pub. No.: US 2026/0367642 A1
(43) Pub. Date: Nov. 19, 2026

(54) PATH GENERATION DEVICE AND METHOD, AND A MOBILE OBJECT

(71) Applicant: HYUNDAI WIA Corporation, Changwon-si (KR)

(72) Inventors: Dong Joon Lee, Uiwang-si (KR); Jeong Min Choi, Uiwang-si (KR)

(73) Assignee: HYUNDAI WIA Corporation, Changwon-si (KR)

(21) Appl. No.: 19/674,428

(22) Filed: May 12, 2026

(30) Foreign Application Priority Data
May 13, 2025 (KR) 10-2025-0062163

(51) Int. Cl. G05D 1/644; B60W 60/00; G05D 1/622; G05D 1/639

(52) U.S. Cl. CPC G05D 1/644; B60W 60/001; G05D 1/622; G05D 1/639; B60W 2520/06; B60W 2554/4041; B60W 2720/24

(57) ABSTRACT

A path generation device, a path generation method, and a mobile object are provided. The path generation device includes a processor configured to determine a plurality of nodes including position information and direction information based on a start node of a mobile object and a destination node; determine a movement cost from each of the plurality of nodes to an adjacent node based on the position information, the direction information, and a movement method from each of the plurality of nodes to the adjacent node; and determine a driving path from the start node to the destination node based on the movement cost. The path generation device further includes an output device configured to output information corresponding to the driving path to a controller of the mobile object. The mobile object is controlled by the controller to move along the driving path.

### CROSS-REFERENCE TO THE RELATED APPLICATION

This application claims the benefit of and priority to Korean Patent Application No. 10-2025-0062163 filed on May 13, 2025 in the Korean Intellectual Property Office, the entire contents of which are incorporated herein by reference.

### TECHNICAL FIELD

The present disclosure relates to a path generation device, a path generation method, and a mobile object that consider rotation and movement methods.

### BACKGROUND

A device to which a technology for generating a path from a start point to a destination point is applied is referred to as a driving path generation device.

Such driving path generation technology may be applied to various types of mobile objects, such as vehicles, parking robots, and logistics transport robots, contributing to reducing user intervention, improving autonomous driving capabilities of mobile objects, and increasing operational efficiency.

The matters described as background art above are intended only to enhance understanding of the background of the present disclosure and should not be taken as an acknowledgment that they correspond to prior art already known to a person having ordinary skill in the art.

### SUMMARY

The present disclosure is intended to provide a driving path generation device, a driving path generation method, and a mobile object capable of generating a driving path by considering rotation and movement methods of a mobile object.

Also, the present disclosure is intended to provide a driving path generation device, a driving path generation method, and a robot capable of preventing unnecessary rotation of a mobile object.

Also, the present disclosure is intended to provide a driving path generation device, a driving path generation method, and a robot capable of passing through a narrow space by considering the shape of a mobile object.

The technical objectives to be achieved in the present disclosure are not limited to the technical objectives mentioned above, and other technical objectives not mentioned should be clearly understood by a person having ordinary skill in the art to which the present disclosure belongs from the following description.

A path generation device according to the present disclosure for achieving the above objectives may include a processor configured to determine a plurality of nodes including position information and direction information based on a start node of a mobile object and a destination node of the mobile object. The processor is further configured to determine a movement cost from each of the plurality of nodes to an adjacent node based on the position information, the direction information, and a movement method from each of the plurality of nodes to the adjacent node. The processor is further configured to determine a driving path from the start node to the destination node based on the movement cost. The path generation device may further include an output device configured to output information corresponding to the driving path to a controller of the mobile object. The mobile object may be controlled by the controller to move along the driving path.

According to an example, the movement method may include at least one of forward driving, reverse driving, lateral crab driving, or rotation.

According to an example, the processor may be further configured to determine the movement cost based on a predetermined cost corresponding to each of the movement methods.

According to an example, the predetermined cost may be set based on an estimated time for a movement of the mobile object from each of the plurality of nodes to the adjacent node through each of the movement methods.

According to an example, the processor may be further configured to, prior to generating the driving path, exclude impassable nodes from the plurality of nodes based on the position information and the direction information of the plurality of nodes and obstacle position information.

According to an example, the processor may be further configured to determine an obstacle node corresponding to a position of an obstacle as the impassable node.

According to an example, the processor may be configured to determine, among the plurality of nodes, an obstacle-oriented node as the impassable node, the obstacle-oriented node having position information corresponding to a position adjacent to the obstacle node and direction information oriented toward the obstacle node.

According to an example, the processor may be configured to determine the impassable nodes by further considering overall length information of the mobile object moving along the driving path and overall width information of the mobile object.

According to an example, the plurality of nodes may include N nodes having the same position information and respectively having different direction information.

According to an example, the processor may be configured to determine the movement cost based on a first cost corresponding to a time for a movement of the mobile object from a position of each of the plurality of nodes to a position of the adjacent node, a second cost corresponding to a time for a movement of the mobile object from a direction of each of the plurality of nodes to a direction of the adjacent node, and a third cost corresponding to a movement method for a movement of the mobile object from each of the plurality of nodes in the direction of the adjacent node.

A path generation method according to the present disclosure may include determining, by a controller, a plurality of nodes including position information and direction information, based on a start node of a mobile object and a destination node of the mobile object. The path generation method may further include determining, by the controller, a movement cost from each of the plurality of nodes to an adjacent node, based on the position information, the direction information, and a movement method from each of the plurality of nodes to the adjacent node. The path generation method may further include determining, by the controller, a driving path from the start node to the destination node based on the movement cost. The path generation method may further include outputting, by an output device, the driving path to a controller of the mobile object. The mobile object is controlled by the controller to move along the driving path.

According to an example, the movement method may include at least one of forward driving, reverse driving, lateral crab driving, or rotation.

According to an example, determining the movement cost may include determining the movement cost from each of the plurality of nodes to the adjacent node based on a predetermined cost corresponding to each of the movement methods.

According to an example, the predetermined cost may be set based on an estimated time for a movement of the mobile object from each of the plurality of nodes to the adjacent node through each of the movement methods.

According to an example, the path generation method may further include, prior to determining the driving path, excluding impassable nodes from the plurality of nodes based on the position information and the direction information of the plurality of nodes and obstacle position information.

According to an example, excluding the impassable nodes may include excluding an obstacle node corresponding to a position of an obstacle.

According to an example, excluding the impassable nodes may include excluding, among the plurality of nodes, an obstacle-oriented node having position information corresponding to a position adjacent to the obstacle node and direction information oriented toward the obstacle node.

According to an example, excluding the impassable nodes may include determining the impassable nodes by further considering overall length information of the mobile object moving along the driving path and overall width information of the mobile object.

According to an example, determining the plurality of nodes may include generating, the controller, N nodes having the same position information and respectively having different direction information.

A robot according to the present disclosure may include a drive device; and a robot controller configured to generate a plurality of nodes including position information and direction information based on a start node and a destination node. The robot controller is further configured to determine a movement cost from each of the plurality of nodes to an adjacent node based on the position information, the direction information, and a movement method from each of the plurality of nodes to the adjacent node. The robot controller is further configured to generate a driving path from the start node to the destination node based on the movement cost. The robot controller is further configured to control the drive device to follow the driving path.

According to an example of the present disclosure, a driving path generation device, a driving path generation method, and a robot capable of generating a driving path by considering rotation and movement methods of a mobile object may be provided.

Also, a driving path generation device, a driving path generation method, and a robot capable of preventing unnecessary rotation of a mobile object may be provided.

Also, a driving path generation device, a driving path generation method, and a robot capable of passing through a narrow space by considering the shape of a mobile object may be provided.

The effects obtainable from the present disclosure are not limited to the effects mentioned above, and other effects not mentioned should be clearly understood by a person having ordinary skill in the art to which the present disclosure belongs from the following description.

### BRIEF DESCRIPTION OF THE DRAWINGS

The above and other objects, features, and other advantages of the present disclosure should be more clearly understood from the following detailed description taken in conjunction with the accompanying drawings, in which:

FIG. 1 shows an example path generation controller according to an example;

FIGS. 2-5 explain path generation by a path generation controller according to an example;

FIG. 6 shows an example of a path generation method according to an example;

FIG. 7 is a flowchart for explaining a process of generating a plurality of nodes according to an example; and

FIG. 8 shows an example robot to which a path generation device is applied according to an example.

### DETAILED DESCRIPTION

In describing the examples disclosed in the present specification, when it is determined that a detailed description of related known technologies may obscure the gist of the examples disclosed in the present disclosure, the detailed description thereof has been omitted. In addition, the accompanying drawings are only intended to facilitate understanding of the examples disclosed in the present disclosure. The technical ideas disclosed in the present disclosure are not limited by the accompanying drawings and should be understood to include all modifications, equivalents, and substitutes included within the spirit and technical scope of the present disclosure. The following disclosure is not intended to limit the present disclosure to described forms or specific fields, and it is contemplated that various alternative aspects and modifications of the present disclosure are possible, whether explicitly stated or implied herein. A person having ordinary skill in the art to which the present disclosure belongs should recognize that the form and details of the present disclosure content may change.

The present disclosure content is described with reference to specific aspects. However, as understood by those having ordinary skill in the art to which the present disclosure belongs, the various aspects disclosed herein may be modified in various other ways or otherwise implemented without departing from the spirit and scope of the present disclosure. Accordingly, the following description should be considered as illustrative and for the purpose of teaching those having ordinary skill in the art to which the present disclosure belongs ways to make and use various examples. It should be understood that the forms of the disclosure shown and described herein should be taken as representative examples. Equivalent elements, or materials, processes, or steps, may be substituted for those representatively illustrated and described in the present disclosure. Terms, such as “including,” “comprising,” “incorporating,” “consisting of,” “have,” and “is,” used in describing the present disclosure should be interpreted in a non-exclusive manner, i.e., allowing for the representation of items, components, or elements not explicitly described. In addition, reference to the singular should be construed as encompassing the plural.

In addition, the various examples disclosed in the present specification should be taken in an illustrative and descriptive sense and should not be construed as limiting the content of the present disclosure. All references to joining (e.g., attached, affixed, coupled, connected, etc.) are used only to help understand the present disclosure and are not intended to limit the present disclosure to the position, orientation, or use of components or the methods disclosed herein. Accordingly, joining references should be interpreted broadly. Furthermore, in such joining references, it is not concluded that two or more elements are directly connected to each other. Additionally, all numeric terms, for example “first,” “second,” “third,” “primary,” “secondary,” “main,” or any other general or numeric term, should be taken only as identifiers to assist in understanding various components, forms, variations, or modifications of the present disclosure. The terms are not meant to imply any limitation on any component, form, variation, modification, or order or preference thereof. In other words, such terms may be used to describe various components, but the components are not limited by such terms. Such terms are used only for the purpose of distinguishing one component from another component.

The terms “module” and “unit” for components used in the following description are given or used interchangeably based on ease of description only and do not themselves have distinct meanings or roles. When a controller, module, unit, component, device, element, or the like of the present disclosure is described as having a purpose or performing an operation, function, or the like, the controller, module, unit, component, device, element, or the like should be considered herein as being “configured to” meet that purpose or to perform that operation or function. Each controller, module, unit, component, device, element, and the like may separately embody or be included with a processor and a memory, such as a non-transitory computer readable media, as part of the apparatus.

When a component is described as being “connected to” or “coupled to” another component, it should be understood that it may be directly connected or coupled to the other component, or other components may exist between the two components. In contrast, when a component is described as being “directly connected to” or “directly coupled to” another component, it should be understood that there are no other components between the two components.

In addition, the Unit or Control Unit included in a name is merely a term widely used in the naming of a controller that controls a specific function of a vehicle and does not mean a generic function unit.

A controller may include a communication device that communicates with other controllers or sensors to control functions under its responsibility, a memory that stores operating systems, logic commands, and input/output information, and one or more processors that perform judgment, computation, and decision making necessary for controlling the functions under its responsibility.

Any number or various components in any configuration described herein may be included within the disclosure described herein. Components may include any combinations of features described herein and may be arranged in any of the various configurations described herein. Concepts related to the structure and arrangement of components of the present disclosure, as well as their use and operation, may be applied to any number of examples in any combination, as well as the specific examples discussed herein. Examples having various features in various arrangements are described below with reference to the drawings.

Hereinafter, various examples disclosed in the present disclosure are described in detail with reference to the accompanying drawings, and the same or similar components are given the same reference numerals regardless of reference numerals, and redundant descriptions thereof have been omitted.

A device to which a technology for generating a path from a start point to a destination point of a mobile object is applied is referred to as a path generation device. For example, a path generation device may be implemented in the form of a controller or a vehicle, logistics robot, or parking robot including the controller. As another example, a path generation device may be implemented in the form of a server.

In the following description, an example in which a path generation controller corresponding to the path generation device is mounted on a vehicle and implemented in the form of generating a driving path of the vehicle is mainly described. However, this is merely for convenience of description, and the technical scope of the present disclosure is not limited thereto.

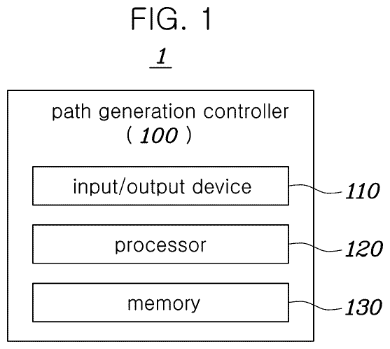

FIG. 1 shows an example path generation controller according to an example.

Referring to FIG. 1, a path generation controller 100 including an input/output device 110, a processor 120, and a memory 130 is illustrated.

The input/output device 110 may obtain start position information, start direction information, destination position information, destination direction information, obstacle information, and the like and may transmit them to the processor 120 or output information corresponding to a generated driving path to the exterior. For example, in an example in which the path generation controller 100 is applied to a vehicle, the input/output device 110 may obtain basic information including start position information, start direction information, destination position information, destination direction information, obstacle information, and the like from a navigation terminal, a control server, or the like, may transmit it to the controller 120, and may transmit the driving path generated by the controller 120 to a vehicle controller (e.g., Vehicle Control Unit (VCU)).

The processor 120 may generate a driving path in which rotation and movement methods are considered. For example, the processor 120 may determine a plurality of nodes including position information and direction information based on a start node and a destination node. The processor 120 may determine a movement cost from each of the plurality of nodes to an adjacent node based on the position information, the direction information, and a movement method from each of the plurality of nodes to the adjacent node. The processor 120 may determine a driving path from the start node to the destination node based on the movement cost.

The memory 130 may store information necessary for generating the driving path. For example, the memory 130 may store map information around a vehicle provided to the processor 120 and a preset movement cost corresponding to the movement method.

According to an example, the path generation controller 100 may be implemented in a vehicle that includes a drive device and a drive controller that controls the drive device to follow the driving path determined by the path generation controller 100. Here, the drive device should be understood as a concept that includes a power source, a braking device, and a steering device. Hereinafter, a process in which the path generation controller 100 generates a path is described focusing on an example in which the path generation controller 100 is implemented in a vehicle.

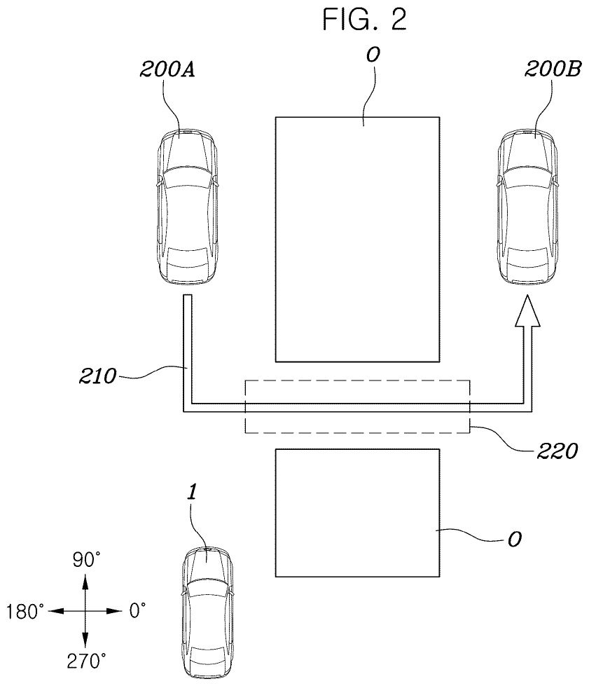

FIGS. 2-5 are for explaining path generation by a path generation controller according to an example.

Referring to FIG. 2, a start pose 200A corresponding to a state of the vehicle 1 in a case where the start direction at a start position is a direction of 90 degrees, a destination pose 200B corresponding to a state of the vehicle 1 in a case where a target destination direction at a target destination position is a direction of 90 degrees, a driving path 210 generated based on the start pose 200A and the destination pose 200B, and a narrow section 220 caused by an obstacle O are illustrated.

The processor 120 may generate the driving path 210 having the smallest cost for the vehicle 1 to reach from the start pose 200A to the destination pose 200B.

Here, in a case where the narrow section 220 caused by the obstacle O exists, the processor 120 may generate a driving path in which movement of the vehicle 1 is not impeded by the obstacle O.

For example, because it is not possible to pass through the narrow section 220 by reversing the vehicle 1 from the start pose 200A in a direction of 270 degrees and then performing crab driving in a direction of 0 degrees, and the destination pose 200B faces a direction of 90 degrees again, the processor 120 may generate the driving path 210 involving a direction change, based on a movement method that does not impede movement before and after the narrow section 220.

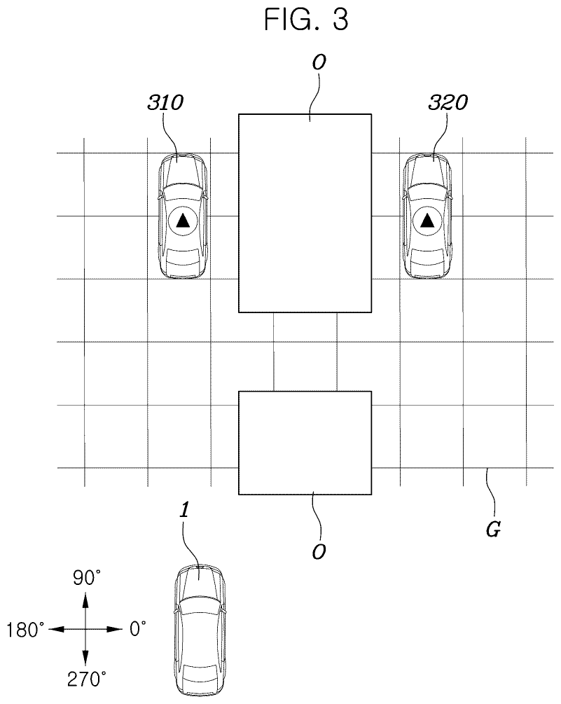

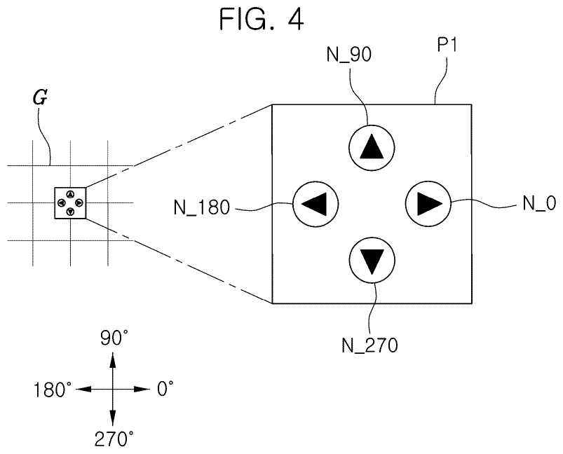

Referring to FIG. 3, a start node 310 corresponding to the start pose 200A at the start position of the vehicle 1, a destination node 320 corresponding to the destination pose 200B at the destination position, and a grid G including the start node 310 and the destination node 320 are illustrated. Referring to FIG. 4, four nodes N_0, N_90, N_180, and N_270 located at the first intersection P1 of the grid G among the plurality of nodes and each having different direction information are illustrated.

The processor 120 may generate the grid G including the start node 310 and the destination node 320 as intersections.

For example, the processor 120 may generate the grid G that may include nodes corresponding to the start node, the destination node, and an outer range necessary for detour movement. At this point, the grid G does not necessarily mean only a two-dimensional grid. For example, in a case where the mobile object corresponds to an aerial vehicle rather than the vehicle 1, the grid G may correspond to a three-dimensional grid depending on the type of mobile object.

The processor 120 may generate a plurality of nodes including position information and direction information based on the generated grid G.

Here, the plurality of nodes may include N nodes having the same position information and respectively having different direction information. For example, the processor 120 may generate a first node N_0 having a position corresponding to the first intersection P1 and a direction of 0 degrees, a second node N_90 having a direction of 90 degrees, a third node N_180 having a direction of 180 degrees, and a fourth node N_270 having a direction of 270 degrees.

Also, the processor 120 may, prior to generating the driving path 210, exclude impassable nodes from the plurality of nodes based on position information of the obstacle O.

For example, the processor 120 may determine a node including position information corresponding to a position of the obstacle O among the generated plurality of nodes as an impassable node. Here, the processor 120 may further consider overall length information of the vehicle 1, overall width information, and space information necessary for performing each of the movement methods to determine the impassable node.

As another example, the processor 120 may determine a node as an impassable node, and the node has position information corresponding to a position adjacent to the obstacle node and direction information oriented toward the obstacle node, among the generated plurality of nodes.

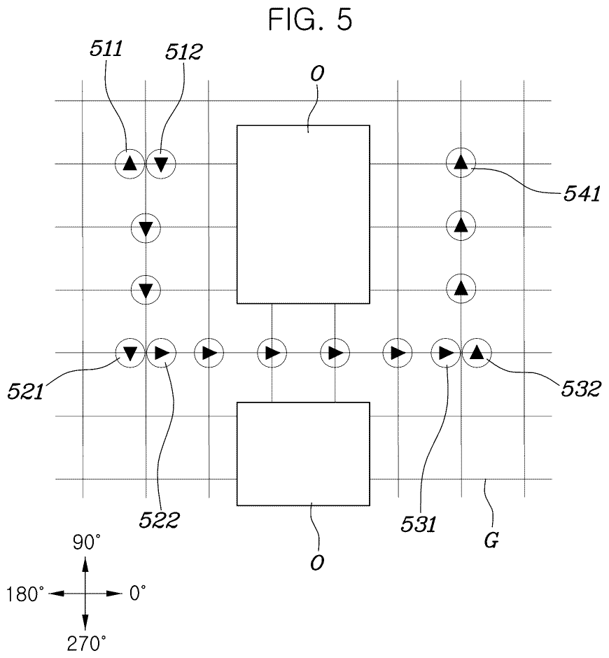

Referring to FIG. 5, a plurality of travel nodes 511, 512, 521, 522, 531, 532, and 541 located on a driving path generated based on a start node 511 and a destination node 541 are illustrated.

The processor 120 may determine a path having the smallest movement cost from the start node 511 to the destination node 541 as the driving path. For example, the processor 120 may determine a driving path that minimizes the movement cost based on an A* algorithm, a D* algorithm, or a Dijkstra algorithm.

The processor 120 may determine the movement cost based on an estimated time required for moving from each of the plurality of nodes to the adjacent node of each of the plurality of nodes.

Here, the adjacent node may include a node having position information adjacent to a reference node and may include a node having the same position information as the reference node but having different direction information from each other.

For example, the second travel node 512 may correspond to an adjacent node having the same position information as the start node 511 but having different direction information, and the sixth travel node 532 may correspond to a node having position information adjacent to the destination node 541.

However, the aforementioned adjacent node is exemplary and is not limited to the aforementioned examples. For example, the adjacent node may further include a node located on a diagonal of the grid G with respect to the reference node.

The processor 120 may determine a first cost corresponding to a time for moving from a position of each of the plurality of nodes to a position of the adjacent node. The processor 120 may determine a second cost corresponding to a time for moving from a direction of each of the plurality of nodes to a direction of the adjacent node. The processor 120 may determine a third cost corresponding to a movement method for moving from each of the plurality of nodes in the direction of the adjacent node, respectively. The processor 120 may determine a final movement cost as the sum of the first cost, the second cost, and the third cost.

Here, the third cost may be set based on an estimated time for moving from each of the plurality of nodes to the adjacent node through each of the movement methods.

For example, the movement methods include forward driving, reverse driving, and rotation, and the third cost corresponding to forward driving may be set to 1, the third cost corresponding to reverse driving may be set to 2, and the third cost corresponding to 90-degree rotation may be set to 2, respectively. In this case, the processor 120 may determine the third cost for moving from the start node 511 to the second travel node 512 as 4. The processor 120 may determine the third cost for a movement from the second travel node 512 to the third travel node 521 as 3. The processor 120 may determine the third cost for a movement from the third travel node 521 to the fourth travel node 522 as 2. The processor 120 may determine the third cost for a movement from the fourth travel node 522 to the fifth travel node 531 as 5. The processor 120 may determine the third cost for a movement from the fifth travel node 531 to the sixth travel node 532 as 2. The processor 120 may determine the third cost for a movement from the sixth travel node 532 to the destination node 541 as 3.

However, the aforementioned movement methods and the third costs corresponding to the movement methods are exemplary and are not limited to the aforementioned movement methods and costs.

For example, depending on the structure of the mobile object, the movement methods may further include curved driving involving rotation with a curvature and lateral crab driving involving movement in a lateral direction of the mobile object (in the case of FIG. 5, a direction of 0 degrees or 180 degrees). As another example, the third cost corresponding to the movement method may be set to increase in proportion to the rotation angle. As yet another example, the third cost corresponding to the movement method may be set differently depending on the structure of the mobile object, such as whether the mobile object is capable of rotating in place.

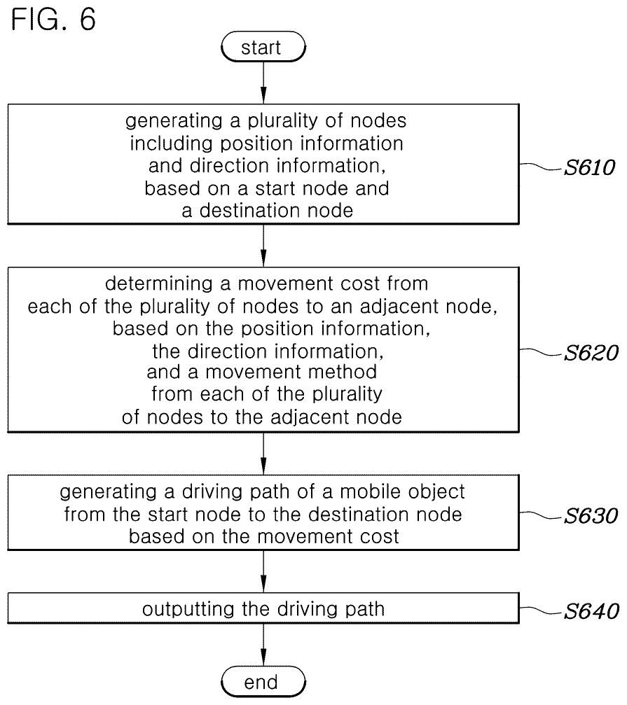

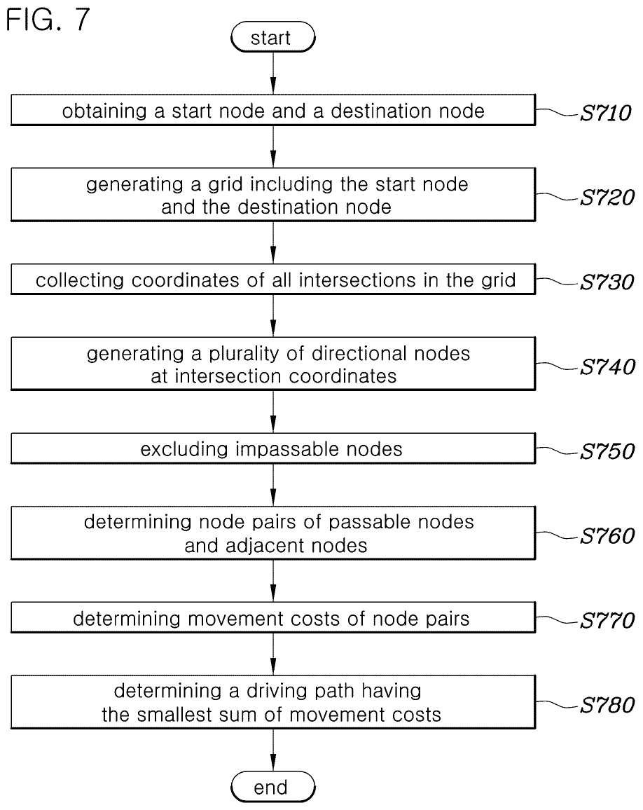

Hereinafter, a method by which the processor 120 according to an example generates a path is described with reference to FIGS. 6 and 7.

FIG. 6 shows an example of a path generation method according to an example.

Referring to FIG. 6, the processor 120 may generate a plurality of nodes including position information and direction information based on a start node and a destination node in step S610. A specific process by which the processor 120 generates the plurality of nodes is described below with reference to FIG. 7.

Also, the processor 120 may determine a movement cost from each of the plurality of nodes to an adjacent node based on the position information, the direction information, and a movement method from each of the plurality of nodes to the adjacent node in step S620.

Also, the processor 120 may generate a driving path of a mobile object from the start node to the destination node based on the movement cost and may output the generated driving path to the exterior in steps S630 and S640.

FIG. 7 is a flowchart for explaining a process of generating a plurality of nodes according to an example.

Referring to FIG. 7, the processor 120 may obtain a start node and a destination node and may generate a grid including the start node and the destination node in steps S710 and S720. Here, the processor 120 may adjust a grid spacing of the generated grid based on path computation performance and power efficiency.

The processor 120 may collect coordinates of all intersections in the grid and may generate a plurality of directional nodes for each of the intersection coordinates in steps S730 and S740.

For example, the processor 120 may generate, for each of all intersection coordinates in the grid, N nodes having position information corresponding to the intersection coordinates and N different pieces of direction information. Here, the number of nodes having the same intersection coordinates and different direction information may be set based on the computational performance of the processor 120.

The processor 120 may exclude impassable nodes in step S750.

For example, the processor 120 may determine impassable nodes based on position information, direction information, and obstacle position information of the plurality of nodes.

The processor 120 may determine node pairs of passable nodes and adjacent nodes and may determine movement costs of the node pairs in steps S760 and S770.

For example, the processor 120 may determine the movement cost based on a first cost corresponding to a time for a movement from a position of each of the plurality of nodes to a position of the adjacent node, a second cost corresponding to a time for a movement from a direction of each of the plurality of nodes to a direction of the adjacent node, and a third cost corresponding to a movement method for a movement from each of the plurality of nodes in the direction of the adjacent node.

The processor 120 may determine a path having the smallest sum of movement costs as the driving path in step S780. For example, the processor 120 may use an optimal path algorithm such as an A* algorithm or a D* algorithm to determine the path having the smallest sum of movement costs.

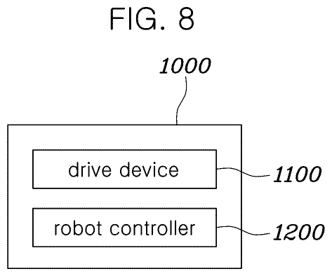

In the examples described so far, the path generation device and the path generation method have been described as being applied to the vehicle 1, but the example is not limited thereto and may be applied to various mobile objects. As an example of such a mobile object, a case in which it is applied to a robot including a drive device is described with reference to FIG. 8.

FIG. 8 shows an example robot to which a path generation device is applied according to an example.

Referring to FIG. 8, a robot 1000 including a drive device 1100 and a robot controller 1200 is illustrated.

The drive device 1100 provides power for movement of the robot 1000 and may move the robot 1000 by following the driving path generated according to a control command provided from the robot controller 1200. For example, the drive device 1100 may include an electric motor, a drive wheel, a drive shaft, a power transmission mechanism, and the like.

The robot controller 1200 may generate a plurality of nodes including position information and direction information based on a start node and a destination node. The robot controller 1200 may determine a movement cost from each of the plurality of nodes to an adjacent node based on the position information, the direction information, and a movement method from each of the plurality of nodes to the adjacent node. The robot controller 1200 may generate a driving path of the robot 1000 from the start node to the destination node based on the movement cost. The robot controller 1200 may control the robot 1000 to follow the generated driving path. In one or more examples, the path generation device (e.g., the path generation controller 100 of FIG. 1) may be implemented as the robot controller 1200, and the input/output device 110, the processor 120, and the memory 130 of FIG. 1 may be included in the robot controller 1200.

In the present disclosure, the description has been centered on examples in which the path generation device is applied to the vehicle 1 and the robot 1000, but this is only for convenience of description, and the path generation device may be similarly applied to various types of mobile objects, such as logistics transfer devices, parking robots, and parking systems.

According to an example of the present disclosure, a driving path generation device, a driving path generation method, and a parking robot capable of generating a driving path by considering rotation and movement methods of a mobile object may be provided.

Also, a driving path generation device, a driving path generation method, and a parking robot capable of preventing unnecessary rotation of a mobile object may be provided.

Also, a driving path generation device, a driving path generation method, and a parking robot capable of passing through a narrow space by considering the shape of a mobile object may be provided.

Meanwhile, the present disclosure described above may be implemented as computer-readable code on a medium on which a program is recorded. The computer-readable medium includes all types of recording devices in which data readable by a computer system is stored. Examples of the computer-readable medium include Hard Disk Drive (HDD), Solid State Disk (SSD), Silicon Disk Drive (SDD), ROM, RAM, CD-ROM, magnetic tape, floppy disk, optical data storage device, and the like. Therefore, the above detailed description should not be construed as limiting in all respects and should be considered as illustrative. The scope of the present disclosure should be determined by reasonable interpretation of the appended claims, and all changes within the equivalent scope of the present disclosure are included in the scope of the present disclosure.

What is claimed is:

1. A path generation device comprising:
a processor configured to:
determine a plurality of nodes including position information and direction information based on a start node of a mobile object and a destination node of the mobile object;
determine a movement cost from each of the plurality of nodes to an adjacent node based on the position information, the direction information, and a movement method from each of the plurality of nodes to the adjacent node; and
determine a driving path from the start node to the destination node based on the movement cost; and
an output device configured to output information corresponding to the driving path to a controller of the mobile object,
wherein the mobile object is controlled by the controller to move along the driving path.

2. The path generation device of claim 1, wherein the movement method includes at least one of forward driving, reverse driving, lateral crab driving, or rotation.

3. The path generation device of claim 1, wherein the processor is further configured to determine the movement cost based on a predetermined cost corresponding to each of the movement methods.

4. The path generation device of claim 3, wherein the predetermined cost is set based on an estimated time for a movement of the mobile object from each of the plurality of nodes to the adjacent node through each of the movement methods.

5. The path generation device of claim 1, wherein the processor is further configured to, prior to generating the driving path, exclude impassable nodes from the plurality of nodes based on the position information and the direction information of the plurality of nodes and obstacle position information.

6. The path generation device of claim 5, wherein the processor is further configured to determine an obstacle node corresponding to a position of an obstacle as the impassable node.

7. The path generation device of claim 6, wherein the processor is further configured to determine, among the plurality of nodes, an obstacle-oriented node as the impassable node, the obstacle-oriented node having position information corresponding to a position adjacent to the obstacle node and direction information oriented toward the obstacle node.

8. The path generation device of claim 5, wherein the processor is further configured to determine the impassable nodes by further considering overall length information of the mobile object moving along the driving path and overall width information of the mobile object.

9. The path generation device of claim 1, wherein the plurality of nodes includes N nodes having the same position information and respectively having different direction information.

10. The path generation device of claim 1, wherein the processor is further configured to determine the movement cost based on a first cost corresponding to a time for a movement of the mobile object from a position of each of the plurality of nodes to a position of the adjacent node, a second cost corresponding to a time for a movement of the mobile object from a direction of each of the plurality of nodes to a direction of the adjacent node, and a third cost corresponding to a movement method for a movement of the mobile object from each of the plurality of nodes in the direction of the adjacent node.

11. A path generation method comprising:
determining, by a controller, a plurality of nodes including position information and direction information, based on a start node of a mobile object and a destination node of the mobile object;
determining, by the controller, a movement cost from each of the plurality of nodes to an adjacent node, based on the position information, the direction information, and a movement method from each of the plurality of nodes to the adjacent node;
determining, by the controller, a driving path from the start node to the destination node based on the movement cost; and
outputting, by an output device, the driving path to a controller of the mobile object,
wherein the mobile object is controlled by the controller to move along the driving path.

12. The path generation method of claim 11, wherein the movement method includes at least one of forward driving, reverse driving, lateral crab driving, or rotation.

13. The path generation method of claim 11, wherein determining the movement cost includes determining the movement cost from each of the plurality of nodes to the adjacent node based on a predetermined cost corresponding to each of the movement methods.

14. The path generation method of claim 13, wherein the predetermined cost is set based on an estimated time for a movement of the mobile object from each of the plurality of nodes to the adjacent node through each of the movement methods.

15. The path generation method of claim 11, further comprising:
prior to determining the driving path, excluding impassable nodes from the plurality of nodes based on the position information and the direction information of the plurality of nodes and obstacle position information.

16. The path generation method of claim 15, wherein excluding the impassable nodes includes excluding an obstacle node corresponding to a position of an obstacle.

17. The path generation method of claim 16, wherein excluding the impassable nodes includes excluding, among the plurality of nodes, an obstacle-oriented node having position information corresponding to a position adjacent to the obstacle node and direction information oriented toward the obstacle node.

18. The path generation method of claim 15, wherein excluding the impassable nodes includes determining the impassable nodes by further considering overall length information of the mobile object moving along the driving path and overall width information of the mobile object.

19. The path generation method of claim 11, wherein determining the plurality of nodes includes generating, by the controller, N nodes having the same position information and respectively having different direction information.

20. A robot comprising:
a drive device; and
a robot controller configured to:
generate a plurality of nodes including position information and direction information based on a start node and a destination node;
determine a movement cost from each of the plurality of nodes to an adjacent node based on the position information, the direction information, and a movement method from each of the plurality of nodes to the adjacent node;
generate a driving path from the start node to the destination node based on the movement cost; and
control the drive device to follow the driving path.
